(19) United States
(12) Patent Application Publication
(10) Pub. No.: US 2007/0003223 A1
(43) Pub. Date: Jan. 4, 2007

(54) User initiated access to secondary content from primary video/audio content

(75) Inventors: James B. Armstrong, Agoura Hills, CA (US); Jorgen P. Makitalo, Agoura Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: PhatCat Media, Inc.

(21) Appl. No.: 11/402,485

(22) Filed: Apr. 11, 2006

Related U.S. Application Data
(60) Provisional application No. 60/670,042, filed on Apr. 11, 2005.

(51) Int. Cl. H04N 7/00

(52) U.S. Cl. 386/95

(57) ABSTRACT

Embodiments of the invention allow viewers of video content to access more information about specific items in a video segment are disclosed. The video content can be movies, video advertisements, TV programs, instructional videos, home videos, surveillance videos, or other video content. The embodiments pertain to content distributed by a standard digital versatile disc (DVD). The embodiments may involve a viewer suspending (or “pausing”) the viewing of motion pictures from a DVD, and then allowing the viewer to access information about items in the video pertinent to the scene where the video was suspended.

### CROSS REFERENCE TO RELATED APPLICATIONS

This application claims priority of U.S. Provisional Patent Application Ser. No. 60/670,042 filed Apr. 11, 2005 entitled “User Initiated Access to Secondary Content from Primary Video/Audio Content.”

### FIELD

Embodiments of the invention relate to accessing supplementary information (e.g., advertising, instructional, historical, product information) related to the primary video/audio information (e.g., items, objects, goods, services, songs, audio, situations, and geographical information) contained on a Digital Versatile Disc (DVD).

### BACKGROUND

In broadcast media, only the primary content is available to viewers. For example, if one is watching a television program and is interested to know what music is playing in the background, there is no way to find out unless it is explicitly mentioned or a vast amount of research is done. This has led to the growth of the product placement business, where a manufacturer is willing to pay the producer to place its product (e.g., car, watch, hotel) in a video production. The producer is responsible for adapting the video content or the script to identify clearly the placed product.

There are two shortcomings with the product placement model. The first is that the script or video content must be adapted to force the product information into the “primary” content. Directors and actors often complain that the artistic integrity of the video production is compromised. Screen shots of logos are annoying and obvious to viewers. The second shortcoming is that only a limited amount and type of product information can be included, because it has to be part of the primary content. For product placement advertisement, this usually means two or three items per movie are placed. Similarly, the type of product information is typically restricted to showing or using a product. The viewer, however, may be quite interested in additional amounts and/or types of information than that which was included in the product placement.

### BRIEF DESCRIPTION OF THE DRAWINGS

The various embodiments of the present invention are illustrated by way of example, and not by way of limitation, in the figures of the accompanying drawings and in which:

FIG. 1A is an example view of suspended video/audio stream primary video content of a DVD with a menu overlay that allows the traversal of a menu structure hierarchy to retrieve secondary information for the scene.

FIG. 1B is another example view example of suspended video/audio stream primary video content of a DVD with a menu overlay that allows the traversal of a menu structure hierarchy to retrieve secondary information for the scene.

FIG. 2A is an example of a hierarchical description showing related primary video content, menus, video chapters, scenes and frames.

FIG. 2B shows an example of index pointers with background frames of a scene.

FIG. 3 is an example of how the video screen will appear when the “menu” or “pause” button on the DVD remote control is pressed.

FIG. 4 is an example of a text menu page appearing after the “wardrobe” button in FIG. 3 is asserted.

FIG. 5 is an example of types of description and/or information a manufacture's product page could access or provide.

FIG. 6 is an example of types of description and/or information a soundtrack menu page could access or provide.

### DETAILED DESCRIPTION

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

Descriptions herein include methods, apparatus and systems for allowing viewers of video content to access more information about specific items in a video segment are disclosed. The video content can be movies, video advertisements, TV programs, instructional videos, home videos, surveillance videos, or other video content. The embodiments pertain to authoring of, data-files (e.g., files, a file-set, an “image” and/or other data authored or otherwise created to produce a DVD from) for producing, and devices including or storing video content. Some embodiments pertain to video content such as content distributed by a standard digital versatile disc (DVD), High definition DVD, flash drives, Hard-drives and the like that can be authored, data-files can be created, and/or can store video content, such as in a DVD format or the like. The embodiments may involve a viewer suspending (or “pausing”) the viewing of motion pictures from a DVD or other video source, and then allowing the viewer to access information about items in the video pertinent to the scene where the video was suspended.

Specifically, interactive media of video sources, such as DVD media, allows the viewer to indicate his/her interest in secondary content. This allows the viewer to immediately retrieve secondary content or information about the primary content without the restrictions of the current product placement methodology. No logo shots or extra information need to be forced into the primary content and thus the artistic integrity of the primary content, movie, artist, actors, writers, etc. is preserved. As a result, an abundance of secondary information can be made available to the viewer at the most relevant place in the video stream of the primary content.

In the following description, numerous specific details such primary video content and play thereof, identifying items or content in the primary video content, indexing primary video content, menu structure and creating thereof, secondary content and display thereof, video scenes, video frames, background frames, items or content in a frame or scene, suspending a video at a point in time, resuming play of a suspended video are set forth to provide a thorough understanding of embodiments of the invention. It can be appreciated that these descriptions apply to embodiments in various forms including as methods, apparatus, systems, and the like applicable to video source authors, producers, users, viewers, and the like. Herein reference to a user, viewer, person, he, she, and the like may be synonymous with respect to performing processes related to authoring a DVD and/or with respect to performing processes related to viewing or playing a DVD.

Embodiments of the invention allow viewers of on-demand and/or DVD video content to access more information about specific items in a video segment. The video content can be movies, video advertisements, television (TV) programs, instructional videos, home videos, surveillance videos, or other video content.

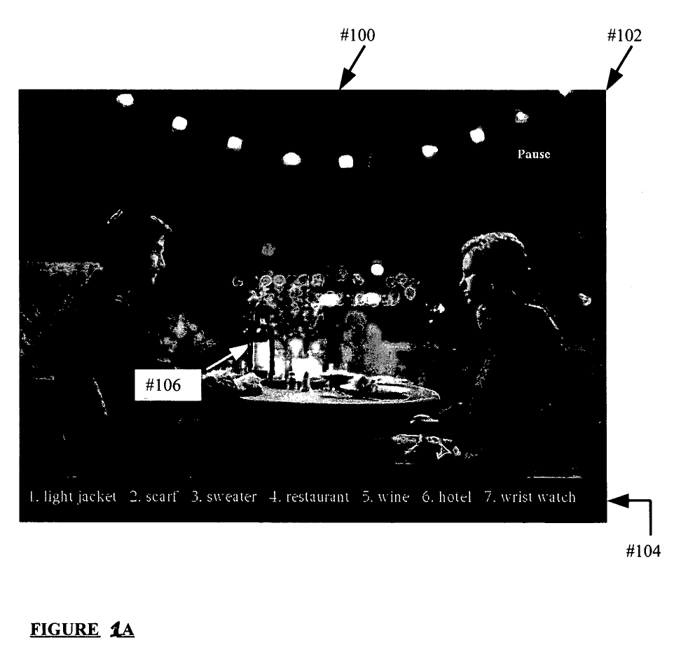

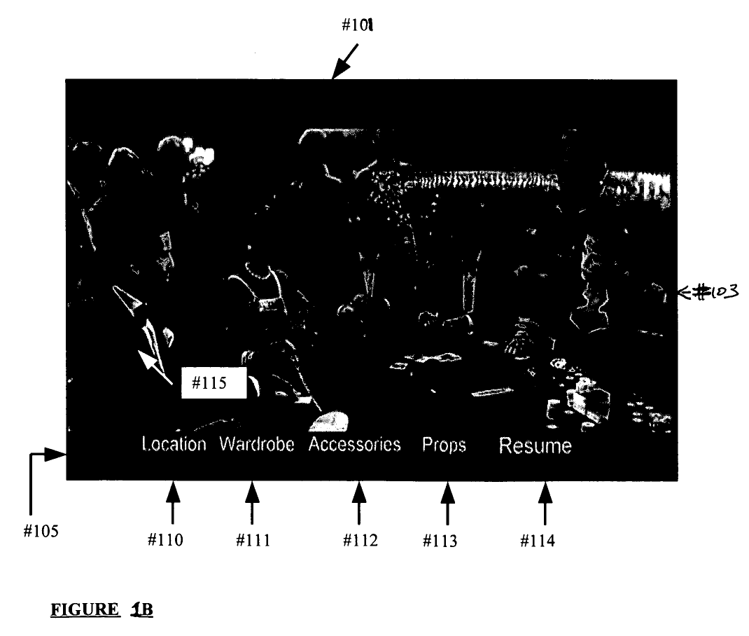

One manifestation of the embodiments is depicted in FIGS. 1A and 1B. FIGS. 1A and 1B are graphic view examples of suspended video/audio stream primary video content of a DVD with a menu overlay that allows the traversal of a menu hierarchy to retrieve (e.g., display or access) secondary information or content (in this case, product information) in the scene. In this particular manifestation, a person is watching a movie on a DVD. He/she presses the “pause” or “menu” button on the remote and the playback of the movie is suspended and the last viewed frame or scene (e.g., a scene may or may not correspond to a chapter, such as by being smaller than, the same size as, or larger than a chapter) is displayed (for some configurable amount of time and/or until the movie is resumed). As shown, displays #100 and #101 display frames #102 and #103 (e.g., a last viewed frame when the button was pushed) above menus #104 and #105 in FIGS. 1A and 1B, respectively. FIG. 1A shows frame #102 having a “pause” indicator and bottle of wine 106. FIG. 1A also shows menu #104 including buttons (e.g., selections) 1 light jacket, 2 scarf, 3 sweater, 4 restaurant, 5 wine, 6 hotel, and 7 wrist watch. FIG. 1B shows frame #103 having character 115; and menu #105 including buttons Location #110, Wardrobe #111, Accessories #112, Props #113, and Resume #114. This may be the result of pressing the “pause” button today on a DVD player. Another manifestation would be to have a fixed background picture (e.g., a pre-selected frame of the frames of the scene), which is a representation of the current scene. However, in this manifestation, a partial overlay appears on the screen that itemizes products within the scene about which the user can get more information. As shown, menus #104 and #105 in FIGS. 1A and 1B respectively, may overlay a lower or bottom portion of displays #100 and #101 (a portion that is or is not displaying video content or frames #102 and #103). For example, if the user highlights and then selects item #5 of menu #104 in FIG. 1A for the wine in the scene, information about the wine is displayed to the user (e.g., information describing the manufacture, year, grape variety, type of wine, cost, and where/how to purchase the wine, such as from a restaurant or store). Similarly, for example, in FIG. 1B if the user highlights and then selects item “Location”, #110, in the scene, information about the location is displayed to the user (e.g., information describing the establishment, business, city, state, country, continent, and the like).

The way this information is displayed can vary. One approach would be to replace the current overlay with another partial overlay that briefly describes the wine or location in FIGS. 1A and 1B, respectively (e.g., an overlay of frames #102 and #103 or menus #104 and #105. Another approach would be to replace the entire video frame with another frame that describes the wine or location. Yet another approach would be to run another video that further describes the wine or location (i.e., hotel) in a more compelling way. In fact, for each product thus indexed in a scene, an entire navigational tree of static descriptions, video images (JPEGs, MPEG stills, or other similar formats), or full motion video clips can be used. For example, if #111 “Wardrobe” is selected, the next menu to appear can identify a number of characters in the scene. The user could then select the character and information about the character's wardrobe appears. Music can also be incorporated into the navigation or menu for the secondary content. For example, the DVD user may want to know what music is being played during the scene. By selecting the music option of the menu for the secondary content, a brief part of the song or audio track can play and information about composer, identification of the piece of music, performers, conductor, studio, location of performance, type of music, instruments, and the like, appears. Thus multiple levels of indirection can be employed to provide secondary information about objects, situations, people, goods, services, items, history, locations, buildings, address, processes (e.g., how to construct, prepare, cook, use, and perform other processes), and the like, in the primary video clip or content. In advertisement applications, this could ultimately be used to purchase the product through the TV (i.e., t-commerce) interface. Initially, it envisioned that a product code is displayed, which a user can enter into a web site online purchase form or over the telephone to buy the product (possibly at a discount that is specific to the secondary content being viewed).

One important aspect of embodiments of this invention is that the user initiates the interruption of the primary video clip to get the secondary information. There is nothing added to the original video or audio components of the primary video to accommodate embodiments of this invention. Thus, the implementation of embodiments of this invention will not alter the playback of the primary video content in any way, until the user initiates the interruption. This feature is important to the content creator for a number of reasons (artistry, story clarity, graphics production, audio production, video information, audio information, synchronization of video information and audio information, and the like).

However, according to embodiments, in some video (e.g., in an educational application) there may be indications or prompts appearing on screen or audio during playback that secondary information is available. For instance, there may be application of such indications or prompts for educational, instructional, learning video etc., were indicators appearing on screen are desirable to show that secondary information is available during certain episodes (e.g., scenes) of video playback. Examples of visual indicators could be but not limited to, icons, text, menus, watermarks, figures, flashing, scrolling banners or solid appearances and the like, to draw attention to viewer. Audio indicators can also be considered during video playback that secondary information is available. Examples of such indicators may be music clip, audio tones, voice, chimes, and the like. This implies that embodiments of the invention pertain to a video-viewing environment that is interactive, like DVD.

Embodiments of this invention encompasses a multitude of manifestations, one of which is described above. A few other manifestations are described in this paragraph. In the above description the “pause” button is pressed. This could be another button, like the “menu” button. In addition, a fixed background can be used when the button is pressed instead of “freezing” the current frame. In addition, upon pressing the button, the video does not have to pause but can keep playing with an overlay displayed as well. While this affects the playback of the original video clip, it was user initiated. As new items are introduced in the primary video, indices to them can be added as they appear in the scenes. Also, in the manifestation described above, the overlay only contains an index of items in the current scene. However, this can be generalized to any duration video segment, which can be a single frame or the entire primary video content.

A natural extension to embodiments of this invention that is covered in this application is to use “hot spots.” When the user presses the “pause” or “menu” button, a still image from the scene would appear. The DVD is authored so that certain items in the scene are “hot spots” so that the user can navigate to an item in the image and select it. For example, instead of selecting #5 in FIG. 1A or “Wardrobe” in FIG. 1B to get information about the wine or what a character is wearing, the user can navigate to the bottle or to the character (e.g., James Bond) in the image and select the bottle 106, or character 115 in FIGS. 1A and 1B, respectively (such as by navigating using arrows, UP/DOWN, LEFT/RIGHT or joystick interface on a remote control or a mouse). Then information about the wine or character's tuxedo, watch, shoes, glasses, wallet, jewelry, clothes, cell phone, computing devices, communications devices (e.g., radio, cell, point to point, telephone, satellite and other communications devices), cosmetics, hair, other aspect of his appearance, actions, and/or statements, and the like would appear. This would also work for many of the other objects in the scene (e.g., characters, furniture, cars).

To return to the primary content, the user can select the resume item on the screen and the video continues from the point it was suspended. It is also possible for the user to select a button on the remote (like “menu” or play) to continue from the point of suspension. Thus, embodiments of the invention pertain to any user-initiated approach to access secondary information from a primary video clip or content, which does not affect the playback viewing of the primary content unless initiated by the viewer.

When a DVD is created (e.g., authored to create a fileset (e.g., a DVD set of files, fileset or “image”) including data for producing a DVD disk), movie or program scenes are divided into video “chunks” called cells. The cell is the fundamental video/audio sequence on the DVD disk. The author can specify commands to execute prior to or after each cell. One implementation of embodiments of the invention would be to add commands prior to each cell that specifies which overlay to use if a “pause” command is received during the playback of the cell. This may be done through a “linkPDC” command. When “pause” is pressed the “linkPDC” command is executed to branch control to the PDC, based on a conditional statements stored in the GPRM and/or SPRM registers, that will display the “menu” of items associated with the cell (e.g., a portion of sub-menu of a menu structure for the primary video content that provides access to secondary content, such as on a scene by scene bases). At this point, the PDC may be authored using standard DVD practices to create a navigation tree of secondary content with one exception. When the “button” is pressed (e.g., when “pause” is pressed a second time), the PDC is exited and the control is passed back to the cell that was last played back to the user (e.g., thus, resuming play of the primary video content at that cell). This again is done using the “linkPDC” command. Thus, the standard virtual DVD command set can be used (with off-the-shelf DVD authoring programs) to implement embodiments of the invention. Some examples of DVD authoring software tools to use to implement embodiments of this invention are Scenarist, “DVD producer HD” by Sonic solutions, DVD-lab Pro v1.5 by MediaChance and other authoring software tools. These software tools are industry standard tools that operate on a personal computer. Many other implementations are possible using the flexible command set of the DVD (e.g., of the DVD specifications and authoring tool capabilities) in addition to the one described here. Those implementations are also covered under this application.

According to embodiments, items in a primary video content may be identified, for which secondary content will be created describing content of scenes of the primary video content. The primary video content may be a movie, DVD, or television (TV) program, having items, goods, services, and songs for which secondary content will provide information or descriptions, such as to allow a viewer to purchase the items, goods, services and songs. The secondary content is then created. Next, a menu structure that allows access to the secondary content is built or created. The primary video content, menu structure and secondary content can then be used to author a DVD. Specifically, the DVD primary video content may be authored with the menu, primary and secondary content to allow the presentation of the menu to access secondary content by suspending presentation of the primary content at a point of suspension. The authoring may allow resumption of the presentation of the primary content at the point of suspension.

According to embodiments, primary video content and secondary content may include various types of video data (e.g., standards, such as NTSC, PAL, SIF (Source Input Format or Standard Interchange Format) and the like), compressed video (e.g., according MPEG or JPEG or other video compression standards, coded video, compiled video, authored audio and/or video information. Moreover, the “content” of the primary video content may include video of scenes, frames, actors, locations, props and the like of movies, shows, programs, and the like. Also, secondary content may include description text, audio, video, and/or graphics of the content of the primary video content (e.g., goods and services shown in the primary video content). Thus, the secondary information can be information and/or types of information in addition to information that identifies the product, such as historical information about a person or situation, instructional information (e.g., how to make, use, cook, repair, etc.), or any related information to a situation, person, song, location, good, service or object in the video content.

The menu structure and secondary content can be information or data that is not included in or part of the primary content (e.g., not included in the “fileset” or “image” to be used to produce a DVD (e.g., “burn”, “press”, or otherwise create a physical DVD having digital code thereon)). For instance, it may not be necessary to change the video information or audio information of the primary video content at all when authoring the DVD to include the menu structure and secondary content. Thus, during play, the video information or audio information of the primary video content will look and sound the same (e.g., to a viewer or user of a DVD produced using the fileset) for DVD authored with and without the menu structure and secondary content.

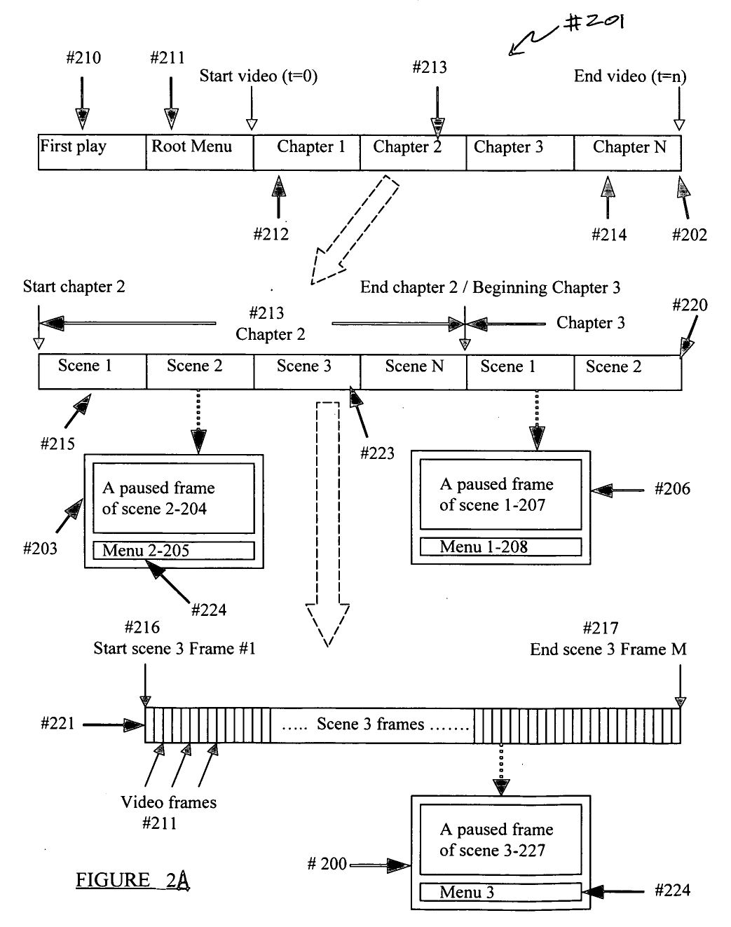

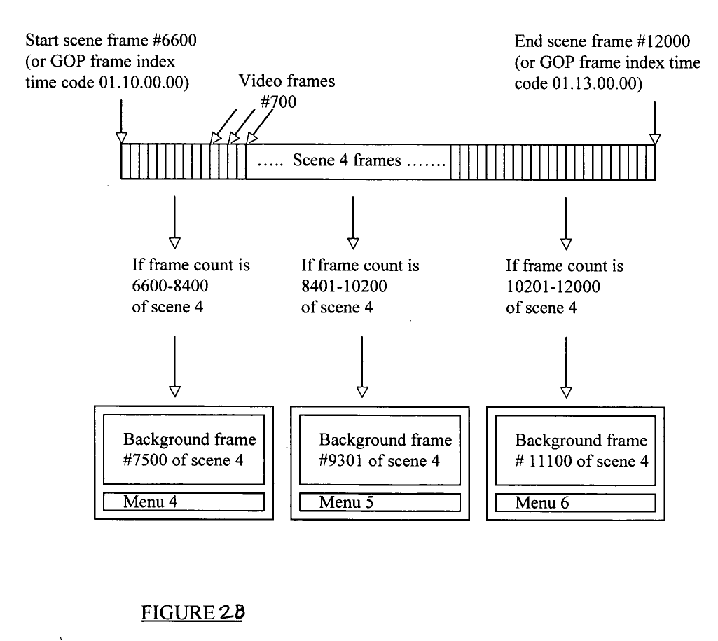

FIG. 2A is a hierarchical description relating to menus and video chapters, scenes and frames. FIG. 2A is a diagram showing an example of how embodiments of this invention's menu structure can be built or implemented prior to or during the DVD authoring process. For instance, the menu structure of movie, show or movie #201 can be built or implemented using standard DVD authoring tools, such as Scenarist, Sonic (e.g., Sonic® DVD Producer™ HD, My DVD™ 8 for Windows XP or Toast® 7 Titanium for Mac OS X, all by Sonic solutions of Novato, Calif., USA), DVDlab (e.g., DVD-lab Pro v1.5 or Studio 1.1, both by Mediachance of Ottawa, Canada) and the like. Stream #202 (e.g., a stream of primary video content) includes first play #210 of movie #201. Play 210 may play automatically when a DVD is placed in a DVD player. An example of were the video chapter indexing program code (e.g., the menu structure of the primary content for this authored DVD, which may be used to display the menu structure and provide access to secondary content as describe herein) is located is in Root Menu #211 which allows users to start a video at different chapters if desired. Menu #211 may be a location where the menu structure of embodiments of the invention will exist when authored as data to be stored and/or when stored on a DVD. Chapters, chapter 1 #212 and chapter 2 #213 show different chapters with Chapter N #214 being the last chapter of the movie. Here, “N” may be a number between 1 and infinity (typically between 10 and 200, such as 1, 2, 4, 8, 10, 20, 40, 80, 100, 200, 400, 800 or a combination thereof) that represents a variable number depending on how long the video is. Stream #220 (part of stream #202) show an example of how a Chapter 2 #213 may be broken down in to a number of scenes, from scene 1, scene 2 to scene N depending how long the video movie #201 is. Stream ##221 shows an example of how Scene 3 #223 may include video frames #211. Frames #211 may include start frame #216 and end frame #217 of scene 3 223. Examples in how to determine were the scene start and ends, is using MPEG group of pictures (GOP) time code indexing or frame count indexing or similar time or frame indexing. For examples, see FIG. 2B.

FIG. 2A also shows display #203 including paused frame 204 of scene 2 of chapter 2 and corresponding menu 205 (e.g., corresponding to scene 2 and/or frame 204; display #206 including paused frame 207 of scene 1 of chapter 3 and corresponding menu 208 (e.g., corresponding to scene 1 and/or frame 208); display 200 including paused frame 227 of scene 3 223 and corresponding menu 224 (e.g., corresponding to scene 3 and/or frame 227). Display #200 show an example of a suspended frame, which may be an original and/or a background frame (e.g., See FIG. 2B), displayed on a monitor or display (such as a television, HD television, computing device monitor or any other monitor capable of displaying video content). Menu 3 #224, may include content or menu choices/selections that appear when the video (e.g., movie #201) is paused. Thus, menu 2 #224, or choices thereof, may be determined according to which scene the video was playing, therefore making the menus dynamic. Dynamic menus may be described as menus that allow suspension of the primary video at points of suspension within scenes to display secondary content for that scene where one or more points of suspension for a scene may or may not be pre-selected (e.g., prior to authoring the DVD). For instance, the dynamic menus may provide a different menu (e.g., a portion or sub-menu of the menu structure) for each scene to access different secondary content for each scene. In some cases, some of these menus and secondary content may be the same for adjacent scenes or scenes that are not adjacent. More particularly, a point of suspension may be defined by one or more indexes, counters, registers (e.g., SPRM (system parameter registers) and/or GPRM (general purpose registers)), register counts, points in time, time indexes, memory addresses, and/or data locations (physical or virtual). For instance, a sub-menu or portion of the menu structure may be correlated with, associated with, or otherwise related to a scene or frame of the primary video content by one or more SPRM (system parameter registers), GPRM (general purpose registers), time indexes, memory address, and/or locations (physical or virtual) of graphics or audio information or data of the primary video content. Similarly, the secondary content may be correlated with, associated with, provide information about, describe, or otherwise related to a scene or frame (or content thereof) of the primary video content by the sub-menu or portion of the menu structure for that scene or frame. Also, note that chapters, scenes, and frames of the primary content shown may or may not be consecutive sequences of content (e.g., they may have gaps in time, index, and/or register count there-between), such as depending on the quality and type of data of the primary content.

Secondary content may be described as or include “more information”, “supplementary information”, “secondary information” related to the primary video and/or audio information contained on a Digital Versatile Disc (DVD). Secondary content may include information in addition to that shown or played in video information (e.g., images, frames, scenes, pictures, items) and/or audio information (e.g., songs, music, sound byte, sound effect, sound even, sound wave (.wav) file, sound scheme, and the like) of a video source. Secondary content may be in a text format, a still image display, a JPEG image, video content, an MPEG 2 clip, audio content, an MP3 clip, an MPEG 4 clip, a JPEG2000 image, or any content compliant to that specified in DVD book B and C of DVD Format/Logo Licensing Corporation (or any of the books published by DVD Format/Logo Licensing Corporation that provide DVD specifications, such as the 19 book series having book B and C, DVD-RW Disc Ver.1.32 February 2006 (editorial), DVD-R Video (VR) Recorder Ver. 1.1 December 2005 (R for DL added), DVD-RAM Disc (4.7/1.46 Gbytes) Ver. 2.2 December 2005 (Class 1 added), DVD-RAM Drive (4.7/1.46 Gbytes) Ver. 2.4 December 2005 (Class 1 added), HD DVD-Video Product Requirement & Guideline Ver.1.0 (September 2005), Ver.1.01 (December 2005), and/or Ver.1.02 (February 2006), all of Tokyo, JAPAN).

Secondary content may identify, describe, further describe, indicate a source of (e.g. a company owning, store, distributor, website, manufacturer of, creator of, source of goods, source of services) an item, song, good, service or situation. In some cases, secondary content may include identification of, description of, advertising, brand, trademark, copyright notice, patent information, instructions, historical information, product information, geographical information (e.g., room, building, street, address, town, city, state, country, latitude, longitude, and similar geographic or location information), and/or other information associated with, related to, or for primary “content” of a video source.

It can be appreciated that primary content may include video, audio, subtitles, images, pictures and other information. Moreover, primary content may include one or more items, goods, songs, services, locations items, objects, goods, art, architecture, services, songs, audio, situations, locations, geography, images, scenes, pictures, songs, music, sound bytes, sound effects, sound even, sound wave (.wav) file, sound scheme, special effects, models, graphics production, graphics effects, audio production, audio effects, audio mixing, and the like), good, or service included in video or audio of the primary video content. Moreover, primary content may include or be included in one or more video movies, shows, chapters, scenes, frames, interlaced frames, images, pictures, and corresponding audio. In some cases, primary content may include content described above for secondary content, and/or vice versa.

Descriptions herein for primary content of a DVD (e.g., a digital video disk, or digital versatile disk), are considered for other sources of video, where applicable, such as video (with or without audio) received from the Internet feed, a local network, streaming video, video on-demand, digital optical or magnetic media, memory, wired or wireless communication, broadcast, movies, video advertisements, television (TV) programs, instructional videos, home videos, surveillance videos, or other video content.

Content (e.g., items, goods, services, and songs) in a primary video content may be identified (e.g., to have secondary content and/or menu structure created or build therefore), such as by a person or DVD author selecting the items by viewing the primary content, with or without the aid of a computing device. In some cases, identifying may be performed automatically by a computing device.

Access to the secondary content may include presenting the secondary content by displaying, playing (e.g., video and/or audio), linking, and other processes for communicating audio and/or video information of the secondary content from a computing device to a person or to another computing device. Access to the secondary content may also include presenting the secondary content as text, video, graphics, icons, audio, and other types of information while the primary video content is suspended.

The term, “scene”, in this document refers to a sequence of one or more frames. In most manifestations of embodiments of the invention, the term scene will correspond to a motion picture scene (e.g., of a movie or feature film, such as produced by a motion picture studio) but in other cases, it may not. For example, if a motion picture scene contains a large number of disparate items over time, then the manifestation may divide the motion picture scene into more than one scene over time (as scene is defined here). Thus, the term, “scene”, in this document may refer to a sequence of one or more frames delineated by movement (e.g., panning or zooming) of the camera taking the video, movement of actors, change of items, change of goods, change of services, change of audio, change of weather, change of lighting, change of location, movement of content, and/or change of content in frames.

Factors considered for selecting scenes include maximizing the number of items, goods, services, songs, and/or other content of the scene for which there are secondary content, maximizing whether it is possible for the menu structure, DVD data, or DVD player to pause at or display a background frame and menu for the content having secondary information (e.g., the menu commands should allow that at least one background frame to be displayed as other than “blank” or “dark” and can be overlaid with menu buttons), whether the types of frames of the scene (e.g., are there sufficient I, P, or B frames) make a scene for the menu structure that is in focus and without effects, whether there is sufficient lighting and proper size/angle of the display of the contents make them easy to see, and whether the frames of the scene have mostly the same people, background, location, props, audio, content having secondary content, and the like.

The menu structure may include a top level menu having invisible menu buttons that overlay specific objects in the still frame. Thus, the authoring, menu structure, indexing, and/or functionality of the DVD data may map the portion of the menu structure to the current scene such that the menu structure is presented during presentation of the current scene. For example, upon suspending play of the primary content, a menu structure having buttons, text, images, graphics, graphical user interface (GUI), hot spots, overlays, a hierarchical menu structure (e.g., sub-menus to the current menu, where the current menu may be described as a portion of sub-menu of the menu structure), and the like may be displayed for the current scene, with or without an image or frame for, from or included in the current scene.

Invisible menu can be described as a menu allowing a user to navigate on the screen (e.g., such as moving a visible or invisible pointer, cursor, or highlighted indicator around the screen using arrows or buttons on a remote control). However, there may not be any menus appearing until the cursor hits an item or predefined place on screen that activates the secondary content menu, such as according to or activated by an invisible overlay to the screen having fields or zones selected to be activated in such a way. The invisible menu could be implemented or displayed over one or more images or frames while in playback mode or suspended mode.

For instance, primary video content of a video source (e.g., a DVD) may be suspended at a point of suspension in time (or according to frame indexing, time frame indexing or GOP time code) of playing or displaying of the primary video content video, audio and other information (e.g., subtitles). After being suspended, the primary video content may be resumed from the point of time of suspension, or a point of time close to that point. A point of suspension in time or frame number may be or include a point defined by a SPRM (system parameter registers), a GPRM (general purpose registers), a time index, a memory address, a data location in memory or on media (physical or virtual), and the like.

As such, building a menu structure and/or authoring a DVD may include dividing the primary content into a sequence of video scenes, that may be consecutive, or may have gaps (e.g., in time, index, and/or register count) there between. Moreover, building a menu structure and/or authoring a DVD may include indexing a beginning and an end of each scene based on a time code and/or a frame count of the primary content of what is appearing on screen to make sub-menus of the menu structure or a portion of the menu structure pertinent to the content (e.g., only pertinent to the content) on a per scene bases. The menu structure may be hierarchical (e.g., a tree structure having more than one branch and/or more than one layer, each with one or more sub-menus or portions) or flat (e.g., a linear structure with one or more sub-menus or portions).

Suspending the presentation may include presenting a still frame that relates to the point of suspension of the video or is within a close time proximity to the point of suspension. Wherein the still frame is part of a background for a menu of items included in the portion of the menu structure.

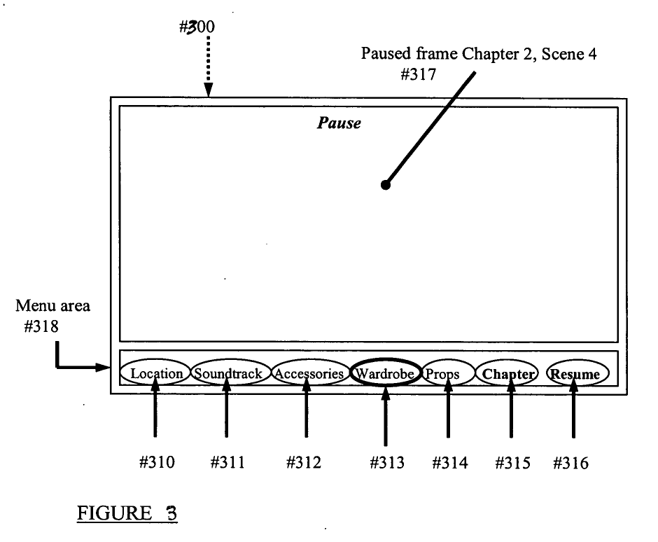

According to embodiments, “overloading” (e.g., overriding) of a menu key may be used to suspend and/or resume play of the primary content. For instance, to suspend the primary video content and display the initial menu (e.g., portion of the menu structure) for secondary content, a button on a standard DVD remote control is pressed. This button can be any button on the remote control device. One example is the “menu” button. This is the button that displays the last menu viewed. To preserve the original functionality of the button, a menu item is added to the initial menu for secondary content (portion of a menu structure for secondary content, such as shown in FIG. 3 and described for “chapter” button (#315) that performs the operation when asserted (e.g., pressed, selected, or activated). Similarly, added to menu #104 or #105 may be a button/menu option that reads “chapter menu” (e.g., not shown in FIGS. 1A and 1B). Thus, a viewer can select a menu button, which will launch the functions to access/display secondary content as described herein (e.g., See FIGS. 1A, 1B, and/or 3-6). However, the first menu screen will have an item marked “chapter menu” (or equivalent) that will perform the functionality of the chapter menu button when asserted (e.g., asserting the “chapter” button (#315) of FIG. 3).

Selecting the menu buttons may cause secondary information about the objects in the frame to be displayed or highlighted. For instance, asserting a button may include manually activating, selecting, depressing, verbally activating, a button on a remote, DVD player or other device that causes a selection at the DVD player or device controlling playing of a DVD. In some cases, asserting a button will suspend play of the primary video content and activate or display a portion or sub-menu of the menu structure corresponding the a current scene being played or displayed. For instance, a current scene may be the scene or a frame of the scene displayed at the time of pressing of the button. The scene or frame displayed during suspension may be described as a “background” scene or frame. However, the current scene or frame may or may not be the background scene.

According to embodiments, asserting a button will suspend play of the primary video content and activate or display a portion or sub-menu of the menu structure corresponding the a scene or frame other than the current scene or frame being played or displayed. For instance, a background scene or frame in this case may be a scene or frame “close in time” to the current scene or a frame displayed at the time of pressing of the button.

According to embodiments, for scenes, close in time may define an adjacent scene. For frames, close in time may be an adjacent frame or a frame that is displayable when play is suspended. For instance, “close in time” may be a frame that is 1, 2, 4, 8, 10, 20, 40, 80, 100, 200, 400, 800 or a combination thereof frames away from the current frame. In some cases, a frame “close in time” may be selected as a background frame because that “close in time” frame is more efficient, superior or beneficial with respect to selection, display, indexing, menu structure, encoding, decoding, and the like. In some cases, factors considered for selecting a background frame include maximizing the chance that it is possible for the menu structure, DVD data, or DVD player to pause at or display a frame (e.g., the menu commands should allow that particular frame to be displayed as other than “blank” or “dark” and to be overlaid with menu buttons), the type of frame (e.g., is it an I, P, or B frame), the frame is in focus (e.g., was the camera panning or zooming at the time), there is sufficient lighting in the frame to see it's contents, contents included and size/angle of the display of the contents make them easy to see and corresponds to the menu structure (e.g., whether the frame includes and clearly shows in an appropriate size some/representative/or all of the content for which the portion of the menu structure and/or secondary content applies/describes), the frame looks nearly like the current frame (e.g., in focus, content, size, lighting).

One purpose for counting frames (e.g., by time, count, and/or registers) to index the beginning and end of the scene, is that indexing will determine which menu structure to display when the primary video has been paused. The frame count is incremented or decremented by one count for each frame being played during video playback.

In some cases, GOP time code is used for indexing. One result of using GOP time code for indexing start and end of a scene during the DVD authoring process (e.g., indexing and/or building a menu structure), is that using GOP time code may not be as accurate as other indexing. If achieving highest accuracy is a goal for indexing the start and end of a scene, then frame indexing may be used (e.g., may be preferred over GOP) during DVD authoring. As the frames are counted (e.g., according to frame count) during video playback the start frame and the end frame of a scene will have frame numbers associated to the scene.

Thus, when play is suspended, each scene may have one or more pre-selected images or frames that will be displayed with the menu structure, depending on where (e.g., the specific frame or frame count) the scene is suspended. FIG. 2B shows an example of index pointers with background frames of a scene. For example, FIG. 2B shows frames #700 of scene 4; start scene frame #6600; end scene frame #12000; background frame #7500 and corresponding menu 4; background frame #9301 and corresponding menu 5; and background frame #11100 and corresponding menu 6. For example, background frame #7500, background frame #9301, and background frame #11100 may be pre-selected background frames related to a current frame when play of a primary video content is suspended.

As shown in FIG. 2B, start of scene frame is frame number 6600, and end of scene is frame number 12000. When the play back frame counter is equal to or greater than the first frame or less than or equal to the last frame of scene 4 is being displayed or played. However, depending exactly where the play back frame counter is (e.g., which frame is the current frame) within, scene 4, different pre-selected frames may be used as a background frame to be displayed with the menu structure. For instance, the program could (e.g., when play is suspended, the menu structure and/or indexing could be programmed to cause the DVD player to) jump (e.g., to reset or update the play back frame counter to) and display a predetermined menu associated with the range of frames for that particular scene. Specifically, if play is suspended at a frame count between (e.g., and including) 6600 and 8400 (e.g., the play back frame counter is at a frame between 6600 and 8400), then background frame #7500 and corresponding menu 4 are displayed (e.g., the play back frame counter may be reset or updated to count 7500). Also, if play is suspended at a frame count between (e.g., and including) 8401 and 10200 (e.g., the play back frame counter is at a frame between 8401 and 10200), then background frame #9301 and corresponding menu 5 are displayed (e.g., the play back frame counter may be reset or updated to count 9301). Finally, if play is suspended at a frame count between (e.g., and including) 10201 and 12000 (e.g., the play back frame counter is at a frame between 10201 and 12000), then background frame #11100 and corresponding menu 6 are displayed (e.g., the play back frame counter may be reset or updated to count 11000).

Moreover, an example of how frame counting may be implemented during DVD authoring is that code could be represented by the following pseudo-code sequence:

1. Increment a frame counter by one as the frames are being viewed in the video stream.

2. Compare frame count to a range of frames.

3. When condition 2 is true, link to menu associated to pre-determined or pre-selected scene number.

This pseudo code can utilize but not be limited to registers such as System parameter registers (SPRM) and General parameter registers (GPRM).

DVD commands considered for indexing primary video content, creating secondary content, building a menu structure therefore, accessing secondary content, suspending and/or resuming play of the primary content include commands according to DVD standards and authoring tools as described herein. For instance, DVD commands considered include the writing and reading of SPRM (system parameter registers) or GPRM (general purpose registers) to store index points that determine the content and portion (e.g., sub-menu) of the menu structure to present.

Moreover, embodiments of the invention pertain to video and audio compression specifications as accepted by DVD Book B and Book C of DVD Format/Logo Licensing Corporation (or any of the books published by DVD Format/Logo Licensing Corporation that provide DVD specifications). This is typically referred to as MPEG-2. In addition, MPEG referred to herein may include various MPEG specifications, such as MPEG 2 and MPEG 4. Also, DVD specifications considered include standard and/or commercial DVD standards such as DVD Book B and DVD Book C.

FIG. 3 is another example of how the video screen will appear when the “menu” or “pause” button on the DVD remote control is pressed. FIG. 3 shows display #300 including frame #317 and menu area #318 having menu categories or buttons #310, #311, #312, #313, #314, #315, and #316. The video stream or primary content is suspended and the last video frame or a background frame is shown as frame #317 (e.g., frame #317 may be a frame pre-selected as a background frame close to and other than the current frame when play was suspended). For example, frame #317 may be a frame of chapter 2, scene 4. A menu structure, which may be or include menu area #318, is overlaid on paused video frame (#300). The menu structure may be a portion of sub-menu of the menu structure for the entire program or movie and may or may not include menu area that overlays frame #317 as well as area #318. Thus, the original video frame of frame #317 may not be modified (e.g., area #318 may be displayed below and not overlap frame #317). The menu categories (e.g., buttons #310, #311, #312, #313, #314, #315, and #316) may dynamically changes on a per scene basis (e.g., the number and type of buttons may change for scenes of the primary content other than chapter 2, scene 4). The menu categories (#318) are relevant to the content of the scene where the video is paused (in this case for chapter 2, scene 4). Navigation to different on-screen buttons of area #318 can be done through standard DVD remote control arrows, UP/DOWN, LEFT/RIGHT or joystick interface. As a user is navigating to buttons on the screen (e.g., pointing to but not yet activating), the buttons may be high lighted or framed (e.g., see dark outline to button #313) to indicate that there is more information to retrieve if the button is activated, selected or asserted (e.g., by pressing select or enter of a remote while a button is highlighted).

According to embodiments, the menu (e.g., portion or sub-menu of menu structure) can be located at various positions on the display and/or with respect to the displayed frame. For instance, menu area #318 in FIG. 3 can be displayed as an overlay on top of video background frame #317 FIG. 3. Alternatively, menu area #318 can be separate from video frame area #317 (e.g., not an overlay). To achieve best visualization and clarity the aspect ratio of the video should be taken in consideration. As an example, in a 4:3 aspect ratio video the menu could be separated from video background area. However in a 16:9 aspect ratio an overlay of video background area may be desirable for best result. These are examples, limitations as other ways of displaying the menu may be used such as partly on and partly off of the frame, and the like.

Play of the primary video content can be started again (e.g., resumed) from the frame that was paused (e.g., frame #317, or a frame close to frame #317 if frame #317 is a background frame other than the current frame when play was suspended) by asserting the “resume” button (#316). The “resume” button resumes the play of primary video content. Asserting the “chapter” button (#315) may navigate you to a chapter selection menu structure normally seen on DVDs. Asserting the “soundtrack” button (#311) may activate a sample of the nearest soundtrack in the video and/or display a description of the soundtrack that was playing when the primary content was suspended. Asserting the “location” button (#310) will identify or describe the location of the primary content shown, or that the suspended scene is filmed at. Examples of location description include identification of structures, geographical areas, towns, cities, restaurants, hotels and the like.

Resuming the video may resume play of the primary video content (asserting the “resume” button (#316)) from a current frame or from the background frame (e.g., when the background frame is not the current frame at which play was suspended). Either way, the primary video content will resume playing (e.g., whatever mode it was playing in previously, such as reverse, fast forward, DTS, full screen, slow, and similar video display or play related functions) from the source (e.g., in the DVD player). Factors considered for selecting a frame to resume playing at, include those described for selecting scenes and for selecting a background frame.

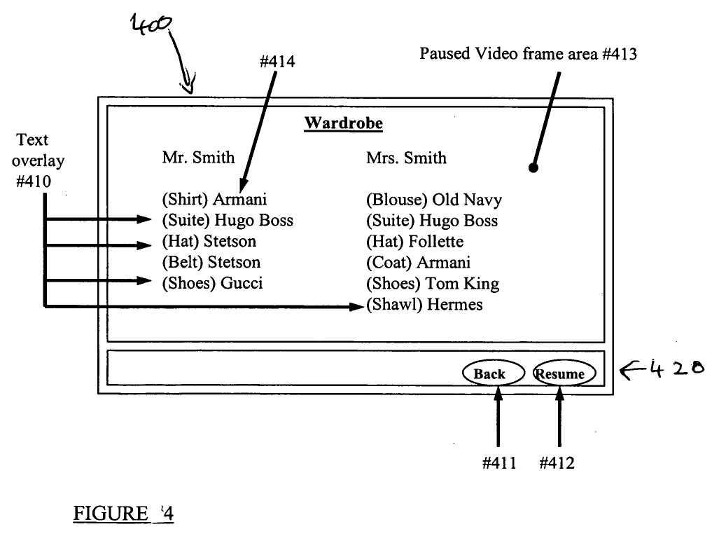

FIG. 4 is an example of a text menu appearing when asserting the “wardrobe” button in FIG. 3. FIG. 4 shows display 400 having frame area #413, overlay #410, and menu 420. Menu 420 includes Back button #411 and Resume button #412. Display 400 is an example of a text menu appearing when asserting the “wardrobe” button (#313) in FIG. 3. A display of text is overlaid on a suspended frame (#413). Specifically, other than the text of overlay #410, overlay #410 may be a “transparent” overlay to frame area #413 so that the frame is visible. The text of overlay #410 is a general list of content of wardrobe items and manufacturers thereof, related to content of the current scene (e.g., chapter 2, scene 4). A user can navigate through the text listing and if text gives indication through high lighting, the user can select or assert that text. Such selection may transition or navigate the user to a menu that will show more detailed information pertaining to text item asserted. For instance, selection of text #414, (Shirt) Amrani, of overlay #410 may transition or navigate the user to a menu that will show more detailed information pertaining to the shirt, or to all Armani® products in the scene, or to all Armani products in the video or movie.

The back button (#411) will go backwards one level to where user navigated or was transitioned from. Resume #412 may be similar to resume #316.

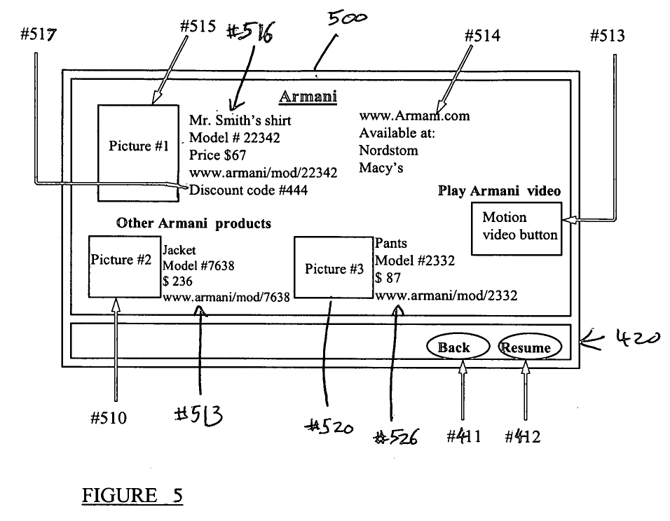

FIG. 5 is an example of what type of description and/or information a manufacture's product page could access or provide. For instance, selection of text #414 of FIG. 4, (Shirt) Armani, of overlay #410 may transition to display 500 of FIG. 5 having Picture #1 (#515) and corresponding description or information (#516), Picture #2 (#510) and corresponding description or information (#513), Picture #3 (#520) and corresponding description or information (#526), purchase location information (#514), and video screen button (#513). Picture #1 (#515) shows an item in current paused scene. This secondary content picture could be of higher resolution format such as JPEG and show much higher degree of detail then possible to observe in the primary video content. Information (#514) shows one or more location(s) and/or websites were Armani items can be purchased (e.g, shows information such as and contact information, website URLs and hot links to websites, store addresses and/or phone numbers. This page could also contain information of other products or services that manufacturers would like to advertise which are/or not included in the video and are not shown in picture #2 and picture #3. At video screen button (#513), a separate video clip can be activated that would demonstrate a process or a product of display 500 in use. The video clip could be activated by asserting on screen button (#513). Alternatively it could be activated by asserting a string of text or could automatically start playing when navigating to display 500 or another pre determined menu. On screen button could also be a motion button (#513), which shows a running video clip and can become expanded when asserted such as a “play” button that expands to show video content.

Another example of secondary content description or information is the display of promotional discount codes for users (e.g., consumers), such as discount code (#517). These promotional codes may be presented at time of purchase.

With Internet access capable DVD players such as HD-DVD, BlueRay DVD or future formats website links (e.g., hotlinks) can be listed were to purchase merchandise or services on Internet sites. As such, building a menu structure and/or authoring a DVD may include creating secondary content, such that selection of a portion of the secondary content links the viewer to the worldwide web (e.g., selects a URL of the Internet). For example, selection of the secondary content (such as the website URL “www.armani/mod/22342” of information #516) may link the viewer to web pages related to the primary content scene, allow the viewer to purchase items related to the primary content (e.g., Mr. Smith's shirt) or secondary content, and/or allow the viewer to post information to websites.

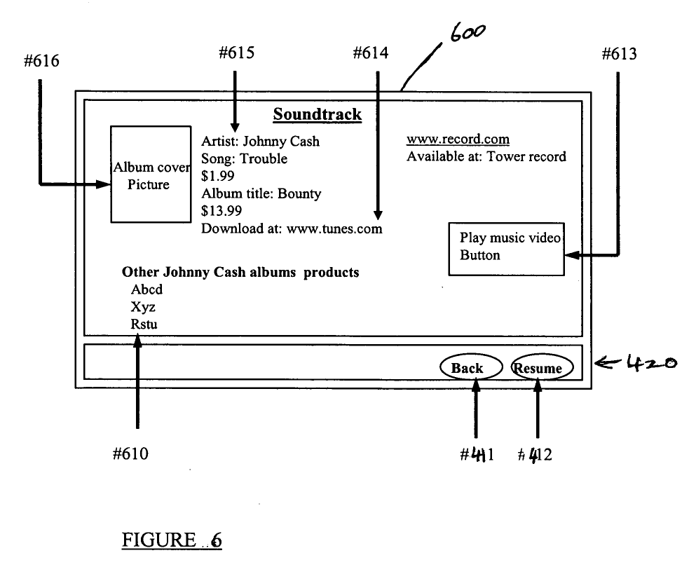

FIG. 6 is an example of what type of description and/or information a Soundtrack product page could access or provide. For instance, selection of soundtrack #311 of FIG. 3, may transition to display 600 of FIG. 6 having Picture (#616) and corresponding description or information (#615), “play music video button” (#613), hotlink (#614), and other Johnny Cash albums products button (#610). In addition, when button (#311) on FIG. 3 is asserted the Soundtrack page (e.g., display 600) would appear and a soundtrack sample may be played for a predefined time as a loop, for a predefined number of repeats or until leaving product page. Soundtrack format can be of any standard audio formats such as MP3, CDA (e.g., music CD playback), WMV (windows media audio), MIDI (musical instrument digital interface), SWF (macromedia flash), AIF (audio interchange file format), WAV (windows audio files), DVD audio and other audio formats, compressions, or codecs. Moreover, information about artist and album is displayed at (#615) and album-cover picture is displayed at (#616). A separate motion video file can be played as a music video as an example by asserting “play music video button” (#613). Other music albums can also be listed and samples can be played (#610). Hotlinks (#614) may be listed to websites for “click thru” to purchase and download single audio files or whole soundtrack album to a separate storage medium, corresponding to as described above for FIG. 5.

Although various descriptions above explain sequences of processes (e.g., identifications, creations, selections, indexing, authoring, storing, video display and play, and the like), the sequences may be re-ordered without departing from the spirit of embodiments of the invention. In addition, in some cases, one or more processes can be excluded without departing from the spirit of embodiments of the invention.

For instance, play of primary content may be suspended and resumed without accessing secondary content. Similarly, play of primary content may be suspended and resumed without activating buttons such as location, soundtrack, accessories, wardrobe, props, and/or chapter. In fact, a user may suspend primary content and not resume, with or without viewing secondary content. In addition, when authoring a DVD, menu structure or secondary content for any of the above buttons may or may not be built or created.

Also, according to embodiments, a computing device may be used to provide or perform the functions of identifying items or content in the primary video content, indexing primary video content, creating a menu structure having sub-menus and portions, selection or division of video scenes, selection of video frames, selection of background frames, suspending a video at a point in time or index, secondary content creation and display for or to describe items or content in a frame or scene, resuming play of a suspended video at or from a current or background frame.

Computing devices contemplated include personal computers (PC), desktop computers, computing systems, portable computing devices, handheld computing devices, Internet related computing devices, servers, digital video disk (DVD) players, graphics production computers and suites, as well as video storage and editing devices. In some cases, the computing device will have a main memory coupled to a processor, an operating system to be executed by the processor, and application or software instructions to perform or assist a person using the computing device in performing the functions described herein.

For instance, authoring tools considered include those that are compliant to a DVD player's coding format standard, such as an MPEG and JPEG standard. In some cases, authoring tools may be standard and/or commercial tools. Alternatively, according to embodiments, an authoring tool may include additional software or application code to provide or perform the functions of identifying items or content in the primary video content, indexing primary video content, creating a menu structure having sub-menus and portions, selection or division of video scenes, selection of video frames, selection of background frames, suspending a video at a point in time or index, secondary content creation and display for or to describe items or content in a frame or scene, resuming play of a suspended video at or from a current or background frame. The additional software or application code may be stored in memory, machine-executable instructions, and/or a machine-accessible medium, such as to be executed by a processor of a computing device to perform or assist a person using the computing device in performing functions described herein. In addition, embodiments included storing the secondary content, menu structure, and/or the primary video content within or on a DVD. It is contemplated that prior to storing the menu structure, and/or content on the DVD, the menu structure, and/or content may be stored, rendered, compiled, and/or created in a memory or medium as digital data, compressed data, application data, coded data, DVD file set compliant with the DVD Books published by DVD Format/Logo Licensing Corporation), or a DVD compiled “fileset” or “image” (e.g., the file or files of data that can be used by a computing device or other electronic device to “burn”, “press”, or otherwise create a DVD, such as by placing or putting data on a “blank” (e.g., having no authored data thereon) or non-blank DVD. In some cases the memory or medium is used to transfer the data (e.g., from a computing device where it is authored) to a device for storing the menu structure, and/or the content within or on a DVD, such as by “burning” or “pressing” a DVD.

For instance, a memory or medium may include or be included in a storage device or computing device. Sometimes, a memory or medium may be described as a “computer-readable medium”, such as a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.

Thus, embodiment may include appropriate electronic or computer hardware and software for performing functions as described above with respect to FIGS. 1-6. Also, it should be appreciated that more or fewer devices and/or processes may be incorporated into the devices and methods illustrated in FIGS. 1-6 without departing from the scope of embodiments of the invention and that no particular order is implied by the arrangement of blocks or figure features shown and described herein. It further will be appreciated that the methods and devices described in conjunction with FIGS. 1-6 may be embodied in machine-executable instructions (e.g. software). The instructions can be used to cause a general-purpose or special-purpose processor that is programmed with the instructions to perform the operations and processes described. Alternatively, the operations and processes might be performed by specific hardware components that contain hardwired logic for performing the operations, or by any combination of programmed computer components and custom hardware components. The methods may be provided as a computer program product that may include a machine-readable medium having stored thereon instructions that may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of embodiment of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

In the foregoing specification, specific embodiments are described. However, various modifications and changes may be made thereto without departing from the broader spirit and scope of embodiments as set forth in the claims. For example, the concepts above may apply to proprietary DVD specifications (e.g., by Microsoft® of Redmond, Wash., and the like), non-standard formats, and/or unofficial specifications (e.g., Unofficial DVD Specification 2.2 or 2.4.12, both by DVD-Replica.com of Houston, Tex., USA, and the like). Also, the concepts above may apply to proprietary DVD authoring tools and/or unofficial authoring tools, and the like. The specification and drawings are, accordingly, to be regarded in an illustrative rather than a restrictive sense.

What is claimed is:

1. A method, comprising:
identifying items in a primary video content for which secondary content will be created;
creating the secondary content;
building a menu structure that allows access to the secondary content;
authoring DVD primary video content to allow the presentation of the menu structure to access the secondary content by suspending presentation of the primary content at a point of suspension in time, and to allow resumption of the presentation of the primary content at the point.

2. The method of claim 1 wherein authoring comprises allowing the display of the secondary content during suspending and creating data-files for producing a DVD.

3. The method of claim 1 wherein the primary video content is a movie, a video advertisement, a television (TV) program, an instructional video, a home video, or a surveillance video; and wherein authoring includes using a DVD authoring tool that is compliant to a DVD players coding format standard.

4. The method of claim 1 wherein the secondary content comprises:
a text format, a still image display, a JPEG image, video content, an MPEG 2 clip, audio content, an MP3 clip, an MPEG 4 clip, a JPEG2000 image, a MP3, CDA (music CD playback), WMV (windows media audio), MIDI (musical instrument digital interface), SWF (macromedia flash), AIF (audio interchange file format), WAV (windows audio files), or content compliant to that specified in DVD book B and C of DVD Format/Logo Licensing Corporation; and
an advertisement, brand, trademark, copyright notice, patent information, description for an item, good, service, or situation included in video or audio of the primary video content.

5. The method of claim 1 further comprising pre-selecting scenes of the primary video content to have a corresponding portion of the menu structure and a portion of the secondary information, wherein pre-selecting includes identifying a beginning and an end of each scene by registers, prior to authoring, and wherein the point of suspension is a point in time measured from a beginning of a scene.

6. The method of claim 1 further comprising dividing the primary content into a sequential plurality of video scenes each having a corresponding portion of the secondary content and a corresponding portion of the menu structure such that the presentation of the primary content is unaffected unless a button is pressed on the remote control or DVD player and wherein pressing the button is to access a portion of the menu structure corresponding the a current scene, and map the portion of the menu structure to the current scene such that the menu structure is presented during presentation of the current scene.

7. The method of claim 6 wherein the authoring includes indexing a beginning and an end of each scene based on a time code of the primary content of what is appearing on screen to make sub-menus of the menu structure pertinent to the content on a per scene bases.

8. The method of claim 6 wherein the authoring includes indexing a beginning and an end of each scene based on a frame count of the primary content of what is appearing on screen to make sub-menus of the menu structure pertinent to the content on a per scene bases.

9. The method of claim 6 wherein authoring comprises adding DVD commands prior to each scene that specify which portion of the menu structure to present for each scene.

10. The method of claim 9 wherein the DVD commands include the writing and reading of SPRM (system parameter registers) registers to store index points that determine the content and portion of the menu structure to present.

11. The method of claim 9 wherein the DVD commands include the writing and reading of GPRM (general purpose registers) registers to store index points that determine the content and portion of the menu structure to present.

12. The method of claim 6 wherein the suspending the presentation includes presenting a still frame that relates to the point of suspension of the video or is within a close time proximity to the point of suspension.

13. The method of claim 12 wherein the still frame is part of a background for a menu of items included in the portion of the menu structure.

14. The method of claim 12 wherein the portion of the menu structure includes a top level menu having invisible menu buttons that overlay specific objects in the still frame.

15. The method of claim 14 wherein selecting the menu buttons causes secondary information about the objects in the frame to be displayed or highlighted.

16. The method of claim 6 further comprising authoring the menus so that selection of a portion of the secondary content links the viewer to web pages of the worldwide web related to the primary content scene to allow the viewer to purchase items related to the primary content or secondary content, or to allow the viewer to post information to websites.

17. A method comprising:
identifying items in scenes of a primary video content for which secondary content will be created;
creating the secondary content including information describing the items;
building a menu structure to access to the secondary content for each scene, wherein each scenes has a beginning and ending defined by registers and portions of the menu structure and portions of the secondary content correlate with each scene;
authoring a DVD to store the primary video content, the secondary content, and the menu structure so that presentation of the primary video content can be suspended at a frame of the scene, by a viewer, to display a portion of the menu structure corresponding to the scene and information describing items in the scene.

18. The method of claim 17 further comprising authoring to display the frame as background to the portion of the menu structure and the information, and authoring to allow resumption of the presentation of the primary content at the frame.

19. A memory storing data-files comprising:
a primary video content comprising a plurality of scenes each having onen or more items;
secondary content describing the items;
menus for each of the scenes so that selection of an item of a frame of the scene displays the secondary content describing the item; and
a menu system to allow a viewer to suspend play of the primary video content at a frame of the scene, to simultaneously display the frame and a menu for the scene, and to allow the viewer to resume playing the primary video content.

20. The apparatus of claim 19, wherein the apparatus comprises one of a memory, a computing device, and a digital versatile disk (DVD), and resuming resumes playing the primary video content at the frame.
